(19) United States
(12) Patent Application Publication
(10) Pub. No.: US 2023/0286850 A1
(43) Pub. Date: Sep. 14, 2023

(54) APPARATUS AND METHOD TO IMPROVE ATTRIBUTES OF DRAWN GLASS

(71) Applicant: Corning Incorporated, Corning, NY (US)

(72) Inventors: Zakaria Allam, Avon (FR); Antoine Gaston Denis Bisson, Painted Post, NY (US); Allan Mark Fredholm, Vulaines sur Seine (FR); Christophe Pierron, Avon (FR); Xavier Tellier, Cheroy (FR)

(21) Appl. No.: 18/019,346

(22) PCT Filed: Aug. 16, 2021
(86) PCT No.: PCT/US2021/046063

§ 371 Date: Feb. 2, 2023

Related U.S. Application Data
(60) Provisional application No. 63/073,626, filed on Sep. 2, 2020.

(51) Int. Cl. C03B 13/04

(52) U.S. Cl. CPC C03B 13/04

(57) ABSTRACT

An apparatus and method for manufacturing a glass article includes a glass delivery device that includes a delivery orifice extending in a widthwise direction and including a first edge region, a central region, and a second edge region. The apparatus and method also include a cooling mechanism proximate the delivery orifice near the first edge region and the second edge region and a heating mechanism proximate the delivery orifice near the central region.

This is a national stage application under 35 U.S.C. § 371 of International Application No. PCT/US2021/046063 filed on Aug. 16, 2021, which claims the benefit of priority under 35 U.S.C. § 119 of U.S. Provisional Application Ser. No. 63/073,626 filed on Sep. 2, 2020, the content of which is relied upon and incorporated herein by reference in their entireties.

### FIELD

The present disclosure relates generally to an apparatus and method to form glass and more specifically an apparatus and method to form glass with improved attributes.

### BACKGROUND

In the production of glass articles, such as glass sheets for display applications, including televisions and hand-held devices, such as telephones and tablets, molten glass can be formed into glass sheets by flowing the molten glass into a glass ribbon from a forming device. Such process typically involves imparting a pulling force onto the glass ribbon as it cools. Depending on the glass composition and the desired thickness of the glass, significant challenges may exist in producing glass sheets with acceptable characteristics, such as thickness uniformity, using a reasonable pulling force. In addition, the width of the glass ribbon tends to contract below the forming device, a phenomenon commonly referred to as ribbon width attenuation. Such attenuation not only reduces the volume of usable glass from a given process but can also adversely affect characteristics such as thickness uniformity. Accordingly, it would be desirable to produce glass sheets, such as increasingly wide and thin glass sheets, with relatively uniform thickness from a variety of different glass compositions.

### SUMMARY

Embodiments disclosed herein include a method of manufacturing a glass article. The method includes forming a glass ribbon from a glass delivery device. The glass ribbon extends in a widthwise direction below a delivery orifice of the glass delivery device and includes a first edge region, a central region, and a second edge region in the widthwise direction. The method also includes positioning a cooling mechanism proximate the delivery orifice near the first edge region and the second edge region. In addition, the method includes positioning a heating mechanism proximate the delivery orifice near the central region.

Embodiments disclosed herein also include an apparatus for manufacturing a glass article. The apparatus includes a glass delivery device that includes a delivery orifice extending in a widthwise direction and includes a first edge region, a central region, and a second edge region. The apparatus also includes a cooling mechanism proximate the delivery orifice near the first edge region and the second edge region. In addition, the apparatus includes a heating mechanism proximate the delivery orifice near the central region.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of a glass making apparatus and process;

FIG. 2 is a schematic perspective end view of a glass manufacturing apparatus that includes a delivery device having a delivery orifice;

FIG. 3 is schematic perspective side view of a portion of the glass manufacturing apparatus of FIG. 2;

FIG. 4 is schematic bottom view of an example glass manufacturing apparatus that includes a cooling mechanism and a heating mechanism in accordance with embodiments herein;

FIG. 5 is a schematic bottom view of an example glass manufacturing apparatus that includes a cooling mechanism and a heating mechanism in accordance with embodiments herein;

FIG. 6 is a schematic perspective end view of an example glass manufacturing apparatus that includes a cooling mechanism and a heating mechanism in accordance with embodiments herein;

FIGS. 7A and 7B are, respectively, schematic top and side cutaway views of an example cooling mechanism in accordance with embodiments disclosed herein;

FIGS. 8A and 8B are, respectively, schematic top and side cutaway views of an example cooling mechanism in accordance with embodiments disclosed herein;

FIGS. 9A and 9B are, respectively, schematic top and side cutaway views of an example cooling mechanism in accordance with embodiments disclosed herein;

FIGS. 10A and 10B are, respectively, schematic top and side cutaway views of an example cooling mechanism in accordance with embodiments disclosed herein;

FIG. 11 is a schematic end view of a portion of an example glass manufacturing apparatus shown in area ‘Y’ of FIG. 6;

FIGS. 12A and 12B are, respectively, schematic top and side views of an example cooling mechanism in accordance with embodiments disclosed herein;

FIGS. 13A and 13B are, respectively, schematic top and side views of an example cooling mechanism in accordance with embodiments disclosed herein;

FIG. 14 is a schematic top view of a portion of an example glass manufacturing apparatus;

FIG. 15 is a schematic top view of a portion of an example glass manufacturing apparatus shown in area ‘X’ of FIG. 4;

FIG. 16 is a schematic side view of a glass ribbon flowing from a delivery orifice; and

FIG. 17 is a chart showing relationships between modeled edge to center viscosity ratios and glass ribbon width under a variety of conditions.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “heating mechanism” refers to a mechanism that either raises the temperature of at least a portion of a glass ribbon or provides reduced heat transfer from at least a portion of the glass ribbon relative to a condition where such heating mechanism is absent. The raised temperature or reduced heat transfer could occur through at least one of conduction, convection, or radiation.

As used herein, the term “cooling mechanism” refers to a mechanism that provides increased heat transfer from at least a portion of the glass ribbon relative to a condition where such cooling mechanism is absent. The increased heat transfer could occur through at least one of conduction, convection, or radiation.

As used herein, the term “molten glass” refers to a glass composition that is at or above its liquidous temperature (the temperature above which no crystalline phase can coexist in equilibrium with the glass).

As used herein, the term “liquidous viscosity” refers to the viscosity of a glass composition at its liquidous temperature.

As used herein, the term “proximate the delivery orifice” refers to a distance that is less than or equal to about 50 millimeters to at least a portion of a delivery orifice of a glass delivery device.

As used herein, the term “near the first edge region” of a glass ribbon refers to a position closer to a first edge of a glass ribbon in its widthwise direction than a central region or a second edge of the glass ribbon in its widthwise direction.

As used herein, the term “near the second edge region” of a glass ribbon refers to a position closer to a second edge of a glass ribbon in its widthwise direction than a central region or a first edge of the glass ribbon in its widthwise direction.

As used herein, the term “near the central region” of a glass ribbon refers to a position closer to a central region of a glass ribbon in its widthwise direction than a first edge or a second edge of the glass ribbon in its widthwise direction.

As used herein, the term “thermally conductive” refers to a material having a thermal conductivity of greater than or equal to about 10 W/m·K at 25° C.

As used herein, the term “thermally insulative” refers to a material having a thermal conductivity of less than or equal to about 2 W/m·K at 25° C.

As used herein, the term “relatively farther” refers to a distance that is at least twice as far from an object, device, or region as a distance that is “relatively closer” to that object, device, or region.

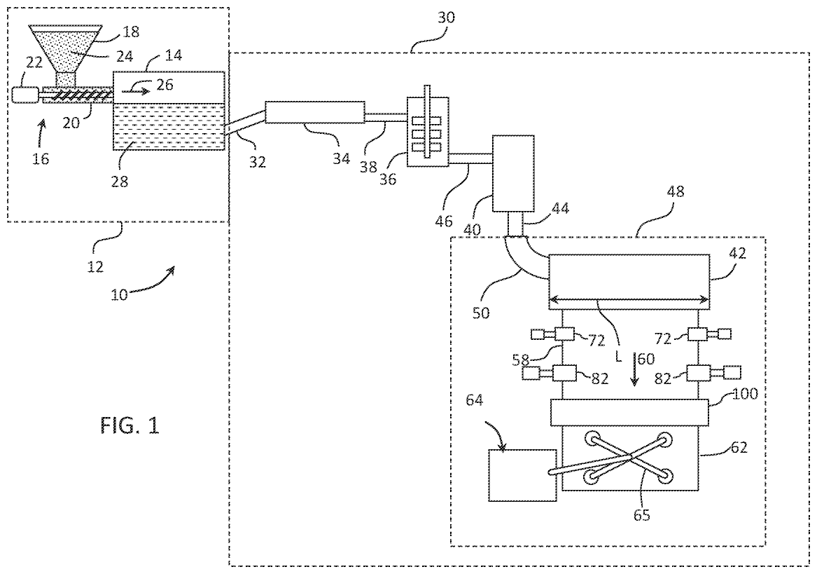

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 includes one or more additional components, such as heating elements (as will be described in more detail herein) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein.

The glass manufacturing apparatus 10 can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw batch materials 24 that can be fed into melting vessel 14 of glass melting furnace 12, as indicated by arrow 26. Raw batch materials 24 typically comprise one or more glass forming metal oxides and one or more modifying agents. In some examples, raw material delivery device 20 can be powered by motor 22 such that raw material delivery device 20 delivers a predetermined amount of raw batch materials 24 from the storage bin 18 to melting vessel 14. In further examples, motor 22 can power raw material delivery device 20 to introduce raw batch materials 24 at a controlled rate based on a level of molten glass sensed downstream from melting vessel 14. Raw batch materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 100% to about 60% by weight platinum and about 0% to about 40% by weight rhodium. However, other suitable metals can include molybdenum, rhenium, tantalum, titanium, tungsten and alloys thereof. Oxide Dispersion Strengthened (ODS) precious metal alloys are also possible.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process or cooled to a temperature lower than the temperature of the molten glass in the melting vessel before entering the fining vessel.

Bubbles may be removed from molten glass 28 within fining vessel 34 by various techniques. For example, raw batch materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced glass delivery device 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Glass delivery device 42 can comprise a delivery orifice (e.g., delivery slot 142 as shown in FIG. 3) through which molten glass flows to produce a single glass ribbon 58 that is drawn in a draw or flow direction 60 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

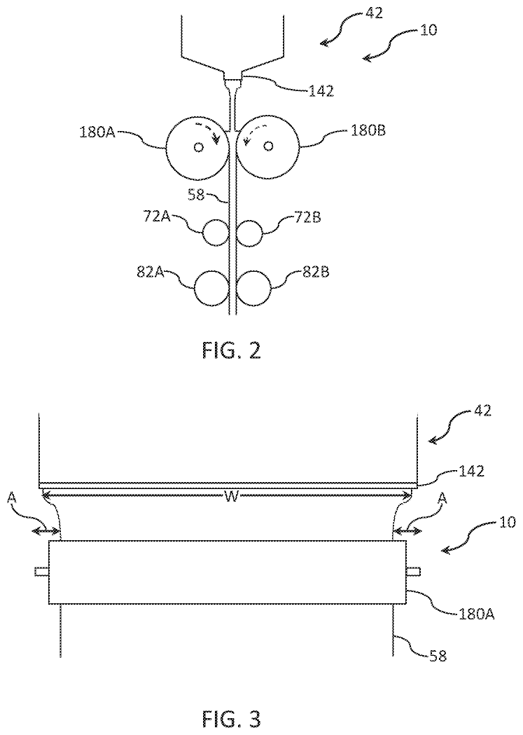

FIG. 2 shows a schematic perspective end view of a glass manufacturing apparatus 10 that includes a glass delivery device 42 that includes a delivery orifice (delivery slot 142). Molten glass flows from delivery slot 142 to form glass ribbon 58. Specifically, glass ribbon 58 flows from glass delivery device 42 and between first forming roll 180A and second forming roll 180B that each respectively rotate in the directions indicated by dashed and curved arrows. Glass ribbon 58 can be further drawn by applying tension thereto, such as by gravity, opposing sets of edge rolls 72A and 72B and opposing sets of pulling rolls 82A and 82B, to control the dimensions of the glass ribbon 58 as the glass cools and a viscosity of the glass increases. And while FIG. 2 shows one set of opposing edge rolls and pulling rolls, embodiments disclosed herein can include more than one set of opposing edge rolls and/or more than one set of pulling rolls.

In certain exemplary embodiments, forming rolls 180A and 180B can be configured in accordance with forming rolls shown and described in WO2009/070236, the entire disclosure of which is incorporated herein by reference. Forming rolls 180A and 180B can be configured so as to provide a controllable adhesion force between the forming rolls 180A and 180B and the glass ribbon 58. The diameter of forming roll 180A and 180B, while not limited to any particular value, may, for example, range from about 20 millimeters to about 500 millimeters and all ranges and subranges in between. In addition, forming rolls 180A and 180B may be comprised of a refractory material, which, while not limited to any particular refractory material, may comprise a metallic material (e.g., stainless steel) and/or a refractory ceramic material.

Forming rolls 180A and 180B may also comprise one or more mechanisms for controlling their temperatures, such as a cooling mechanism, wherein a cooling fluid flows through or around forming rolls 180A and 180B. For example, forming rolls 180A and 180B may comprise at least one channel (not shown) configured to flow a cooling fluid therethrough. Depending on the configuration of temperature control mechanism, the cooling fluid can comprise a liquid, such as water, or a gas, such as nitrogen or air.

A closest distance between glass delivery device 42 and forming rolls 180A and 180B, while not limited to any particular value, may, for example, range from about 10 millimeters to about 1,000 millimeters and all ranges and subranges in between.

FIG. 3 shows a schematic perspective side view of a portion of the glass manufacturing apparatus 10 shown in FIG. 2. As can be seen in FIG. 3, molten glass flows from delivery slot 142 of glass delivery device 42 to form glass ribbon 58, which flows between first forming roll 180A and second forming roll 180B (not shown in FIG. 3). Glass ribbon 58 extends below delivery slot 142 in a widthwise direction (indicated by arrow ‘W’ in FIG. 3). As shown in FIG. 3, glass ribbon 58 extension in the widthwise direction shortens or attenuates between the delivery slot 142 and the first forming roll 180A (which attenuation is indicated by arrows ‘A’). As further shown in FIG. 16, glass ribbon 58 includes a first edge region ‘E1’, a central region ‘C’, and a second edge region ‘E2’ in the widthwise direction.

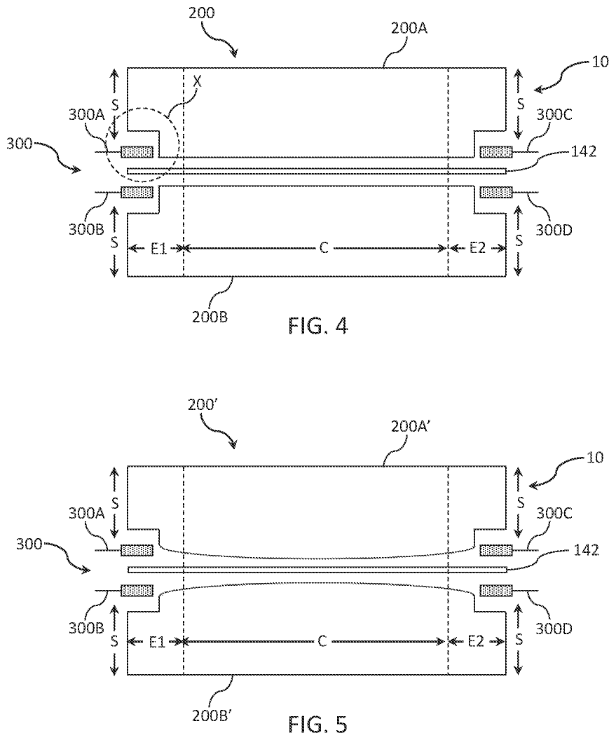

FIG. 4 shows a schematic bottom view of an example glass manufacturing apparatus 10 that includes a cooling mechanism 300 and a heating mechanism 200 in accordance with embodiments herein. Specifically, cooling mechanism 300 includes first cooling mechanism 300A and opposing second cooling mechanism 300B proximate delivery slot 142 near the first edge region ‘E1’. Cooling mechanism 300 also includes third cooling mechanism 300C and opposing fourth cooling mechanism 300D proximate delivery slot 142 near the second edge region ‘E2’. Heating mechanism 200 includes first heating mechanism 200A and opposing second heating mechanism 200B proximate delivery slot 142 near the central region ‘C’.

FIG. 5 shows a schematic bottom view of an example glass manufacturing apparatus 10 that includes a cooling mechanism 300 and a heating mechanism 200′ in accordance with embodiments herein. Similar to the example glass manufacturing apparatus of FIG. 4, cooling mechanism 300 includes first cooling mechanism 300A and opposing second cooling mechanism 300B proximate delivery slot 142 near the first edge region ‘E1’. Cooling mechanism 300 also includes third cooling mechanism 300C and opposing fourth cooling mechanism 300D proximate delivery slot 142 near the second edge region ‘E2’. Heating mechanism 200′ includes first heating mechanism 200A′ and opposing second heating mechanism 200B′ proximate delivery slot 142 near the central region ‘C’. In contrast to heating mechanism 200 of FIG. 4, first heating mechanism 200A′ and second heating mechanism 200B′ of heating mechanism 200′ each include a curved edge proximate delivery slot 142 such that the closest distance between first heating mechanism 200A′ and delivery slot 142 and the closest distance between second heating mechanism 200B′ and delivery slot 142 varies in the widthwise direction along central region ‘C’.

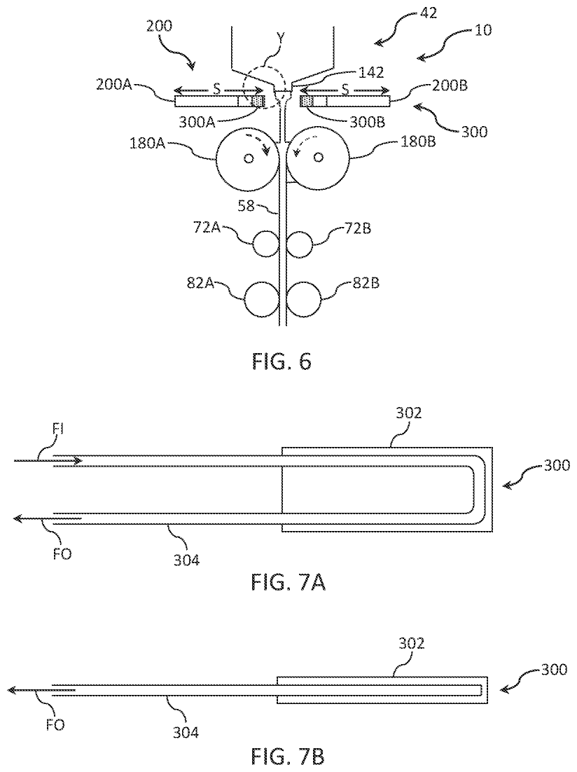

FIG. 6 shows a schematic perspective end view of an example glass manufacturing apparatus 10 that includes a cooling mechanism 300 and a heating mechanism 200 in accordance with embodiments herein. Similar to the example glass manufacturing apparatus of FIG. 4, cooling mechanism 300 includes first cooling mechanism 300A and opposing second cooling mechanism 300B proximate delivery slot 142. Also similar to the example glass manufacturing apparatus of FIG. 4, heating mechanism 200 includes first heating mechanism 200A and opposing second heating mechanism 200B proximate delivery slot 142. And similar to the glass manufacturing apparatus of FIG. 2, glass manufacturing apparatus 10 includes opposing first and second forming rolls 180A and 180B, opposing first and second edge rolls 72A and 72B, and opposing first and second pulling rolls 82A and 82B.

As shown in FIGS. 4-6, the heating mechanism 200 or 200′ comprises first heating mechanism 200A or 200A′ and second heating mechanism 200B or 200B′, wherein first and second heating mechanisms collectively comprise two coplanar thermally insulative plates that are each movable between a first position that is relatively farther from the delivery slot 142 and a second position that is relatively closer to the delivery slot 142. For example, such plates may be slidable between said first and second positions (as indicated by arrow ‘S’ in FIGS. 4-6). Such sliding movement may be enabled by methods known to persons having ordinary skill in the art, such as through use of a servo motor and/or counterweight mechanism, etc.

In certain exemplary embodiments, coplanar thermally insulative plates of heating mechanism 200 or 200′ can comprise a material having a thermal conductivity of less than or equal to about 2 W/m·K at 25° C., such as less than or equal to about 1 W/m·K at 25° C., and further such as less than or equal to about 0.5 W/m·K at 25° C., and yet further such as less than or equal to about 0.2 W/m·K at 25° C., and still yet further such as less than or equal to about 0.1 W/m·K at 25° C., including from about 0.001 W/m·K at 25° C. to about 2 W/m·K at 25° C., such as from about 0.01 W/m·K at 25° C. to about 1 W/m·K at 25° C., and further such as from about 0.05 W/m·K at 25° C. to about 0.5 W/m·K at 25° C.

While not limited to any specific material, in certain exemplary embodiments, coplanar thermally insulative plates of heating mechanism 200 or 200′ may comprise at least one material selected from a refractory thermally insulative ceramic material, such as a refractory thermally insulative ceramic material comprising at least one of alumina or mullite, including but not limited to refractory thermally insulative materials comprising alumina available from Zircar Ceramics.

In certain exemplary embodiments, coplanar thermally insulative plates of heating mechanism 200 or 200′ may comprise a low emissivity surface layer to minimize radiation heat transfer between delivery slot 142 and/or glass ribbon 58 and heating mechanism 200 or 200′. Exemplary low emissivity surface layer materials include, but are not limited to, polished metals, such as polished platinum.

FIGS. 7A and 7B show, respectively, schematic top and side cutaway views of an example cooling mechanism 300 in accordance with embodiments disclosed herein. Cooling mechanism 300 includes thermally conductive member 302 and fluid conduit 304. Fluid conduit 304 is configured to allow a working fluid to flow therethrough, wherein, as shown in FIG. 7A, working fluid enters fluid conduit 304 as shown by arrow ‘FI’ and exits fluid conduit 304 as shown by arrow ‘FO’. As further shown in FIGS. 7A and 7B, fluid conduit 304 extends through thermally conductive member 302, such that cooling mechanism 300 comprises flowing the working fluid through thermally conductive member 302 via fluid conduit 304.

In certain exemplary embodiments, thermally conductive member 302 and/or fluid conduit 304 comprises a material having a thermal conductivity of greater than or equal to about 10 W/m·K at 25° C., such as greater than or equal to about 50 W/m·K at 25° C., and further such as greater than or equal to about 100 W/m·K at 25° C., and yet further such as greater than or equal to about 250 W/m·K at 25° C., including from about 10 W/m·K at 25° C. to about 1,000 W/m·K at 25° C., such as from about 50 W/m·K at 25° C. to about 500 W/m·K at 25° C.

While not limited to any specific material, in certain exemplary embodiments, thermally conductive member 302 and/or fluid conduit 304 may comprise at least one material selected from copper, aluminum, silver, gold, platinum, or nickel and alloys thereof.

Embodiments disclosed herein include those in which working fluid comprises a liquid, such as water, or a gas, such as air, nitrogen, or a noble gas (e.g., helium, neon, argon, etc.). The flowrate and temperature of the working fluid can be adjusted or varied in accordance with methods known to persons having ordinary skill in the art so as to effectuate the desired degree of heat transfer between the cooling mechanism 300 and the delivery slot 142 and/or glass ribbon 58.

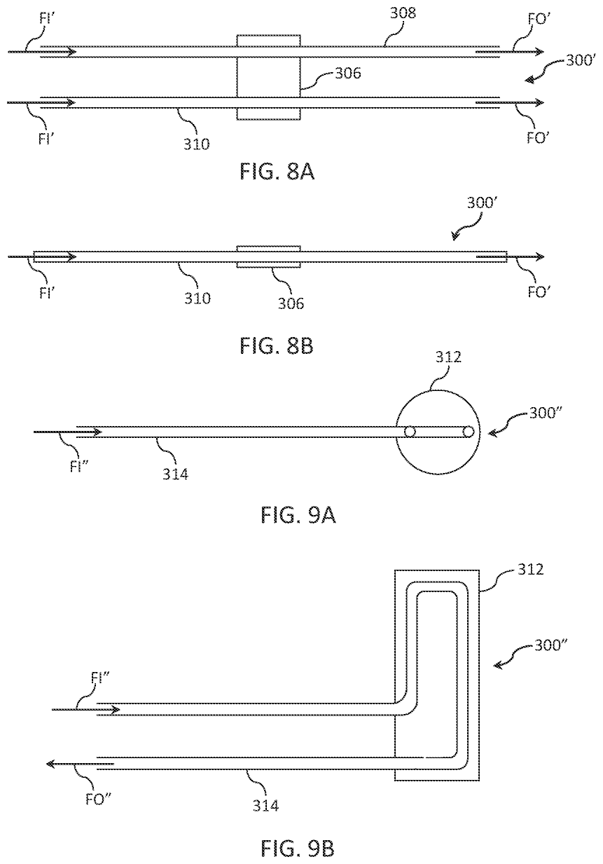

FIGS. 8A and 8B show, respectively, schematic top and side cutaway views of an example cooling mechanism 300′ in accordance with embodiments disclosed herein. Cooling mechanism 300′ includes connecting member 306 that supports and connects fluid conduits 308 and 310. Fluid conduits 308 and 310 are configured to allow a working fluid to flow therethrough, wherein, as shown in FIG. 8A, working fluid enters fluid conduits 308 and 310 as shown by arrow ‘FI′’ and exits fluid conduits 308 and 310 as shown by arrow ‘FO′’.

While not limited to any specific material, in certain exemplary embodiments, connecting member 306 and/or fluid conduits 308 and 310 may comprise a metallic and/or ceramic material, such as a refractory metallic and/or ceramic material.

Embodiments disclosed herein include those in which working fluid comprises a gas, such as air, nitrogen, or a noble gas (e.g., helium, neon, argon, etc.) and cooling mechanism 300′ comprises flowing a gaseous fluid onto delivery slot 142 near the first edge region ‘E1’ and the second edge region ‘E2’. The flowrate and temperature of the gaseous fluid can be adjusted or varied in accordance with methods known to persons having ordinary skill in the art so as to effectuate the desired degree of heat transfer between the cooling mechanism 300′ and the delivery slot 142 and/or glass ribbon 58.

FIGS. 9A and 9B show, respectively, schematic top and side cutaway views of an example cooling mechanism 300″ in accordance with embodiments disclosed herein. Cooling mechanism 300″ includes thermally conductive member 312 and fluid conduit 314. Fluid conduit 314 is configured to allow a working fluid to flow therethrough, wherein, as shown in FIG. 9B, working fluid enters fluid conduit 314 as shown by arrow ‘FI″’ and exits fluid conduit 314 as shown by arrow ‘FO″’. As further shown in FIGS. 9A and 9B, fluid conduit 314 extends through thermally conductive member 312, such that cooling mechanism 300″ comprises flowing the working fluid through thermally conductive member 312 via fluid conduit 314.

In certain exemplary embodiments, thermally conductive member 312 and/or fluid conduit 314 comprises a material having a thermal conductivity of greater than or equal to about 10 W/m·K at 25° C., such as greater than or equal to about 50 W/m·K at 25° C., and further such as greater than or equal to about 100 W/m·K at 25° C., and yet further such as greater than or equal to about 250 W/m·K at 25° C., including from about 10 W/m·K at 25° C. to about 1,000 W/m·K at 25° C., such as from about 50 W/m·K at 25° C. to about 500 W/m·K at 25° C.

While not limited to any specific material, in certain exemplary embodiments, thermally conductive member 312 and/or fluid conduit 314 may comprise at least one material selected from copper, aluminum, silver, gold, platinum, or nickel and alloys thereof.

Embodiments disclosed herein include those in which working fluid comprises a liquid, such as water, or a gas, such as air, nitrogen, or a noble gas (e.g., helium, neon, argon, etc.). The flowrate and temperature of the working fluid can be adjusted or varied in accordance with methods known to persons having ordinary skill in the art so as to effectuate the desired degree of heat transfer between the cooling mechanism 300″ and the delivery slot 142 and/or glass ribbon 58.

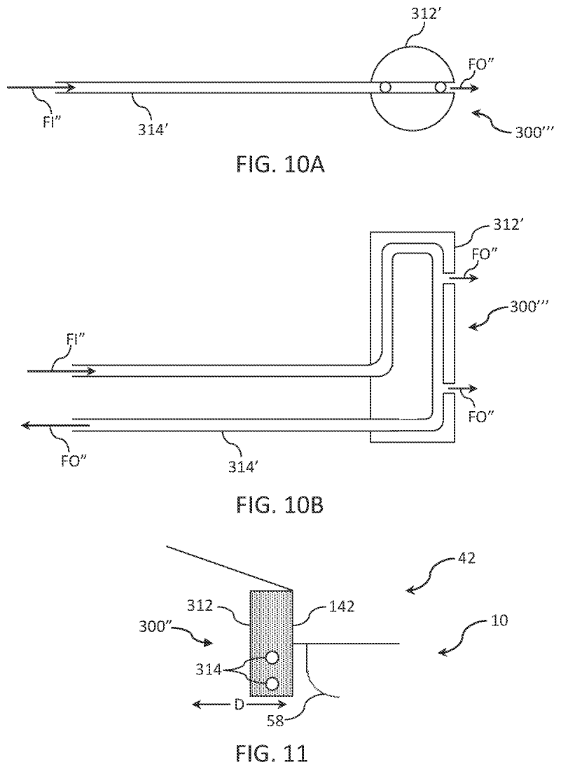

FIGS. 10A and 10B show, respectively, schematic top and side cutaway views of an example cooling mechanism 300′″ in accordance with embodiments disclosed herein. Cooling mechanism 300′″ includes thermally conductive member 312′ and fluid conduit 314′. Fluid conduit 314′ is configured to allow a working fluid to flow therethrough, wherein, as shown in FIGS. 10A and 10B, working fluid enters fluid conduit 314′ as shown by arrow ‘FI″’ and exits fluid conduit 314′ as shown by arrow ‘FO″’. As further shown in FIGS. 10A and 10B, fluid conduit 314′ extends through thermally conductive member 312′, such that cooling mechanism 300′″ comprises flowing the working fluid through thermally conductive member 312′ via fluid conduit 314′.

In certain exemplary embodiments, thermally conductive member 312′ and/or fluid conduit 314′ comprises a material having a thermal conductivity of greater than or equal to about 10 W/m·K at 25° C., such as greater than or equal to about 50 W/m·K at 25° C., and further such as greater than or equal to about 100 W/m·K at 25° C., and yet further such as greater than or equal to about 250 W/m·K at 25° C., including from about 10 W/m·K at 25° C. to about 1,000 W/m·K at 25° C., such as from about 50 W/m·K at 25° C. to about 500 W/m·K at 25° C.

While not limited to any specific material, in certain exemplary embodiments, thermally conductive member 312′ and/or fluid conduit 314′ may comprise at least one material selected from copper, aluminum, silver, gold, platinum, or nickel and alloys thereof.

Embodiments disclosed herein include those in which working fluid comprises a gas, such as air, nitrogen, or a noble gas (e.g., helium, neon, argon, etc.) and cooling mechanism 300′″ comprises flowing a gaseous fluid onto delivery slot 142 near the first edge region ‘E1’ and the second edge region ‘E2’. The flowrate and temperature of the gaseous fluid can be adjusted or varied in accordance with methods known to persons having ordinary skill in the art so as to effectuate the desired degree of heat transfer between the cooling mechanism 300′″ and the delivery slot 142 and/or glass ribbon 58.

While not limited to any specific temperature range, in certain exemplary embodiments, such as those shown in FIGS. 7A-10B, the working fluid can have a temperature ranging from about 0° C. to about 100° C., such as from about 10° C. to about 90° C., and further such as from about 20° C. to about 80° C.

In certain exemplary embodiments, such as those shown in FIGS. 7A-7B and 9A-10B, thermally conductive member 302, 312, or 312′ contacts the delivery slot 142 near the first edge region ‘E1’ and the second edge region ‘E2’. For example, FIG. 11 shows a schematic end view of a portion of an example glass manufacturing apparatus 10 shown in area ‘Y’ of FIG. 6, wherein thermally conductive member 312 of cooling mechanism 300″ contacts delivery slot 142 of glass delivery device 42. Cooling mechanism 300″ includes fluid conduit 314 configured to allow a working fluid to flow therethrough.

Physical contact between cooling mechanism 300″ and delivery slot 142 can effectuate conductive heat transfer between thermally conductive member 312 and delivery slot 142. Distance between cooling mechanism 300″ and delivery slot 142 can be adjusted as shown by arrow ‘D’ in FIG. 11, wherein cooling mechanism 300″ can be moved between a position of physical contact with delivery slot 142 and other positions where cooling mechanisms 300″ is relatively farther away from delivery slot 142, such that an air gap extends between cooling mechanism 300″ and delivery slot 142. Movement of cooling mechanism 300″ relative to delivery slot 142 can be enabled by methods known to persons having ordinary skill in the art, such as through use of a servo motor and/or counterweight mechanism, etc.

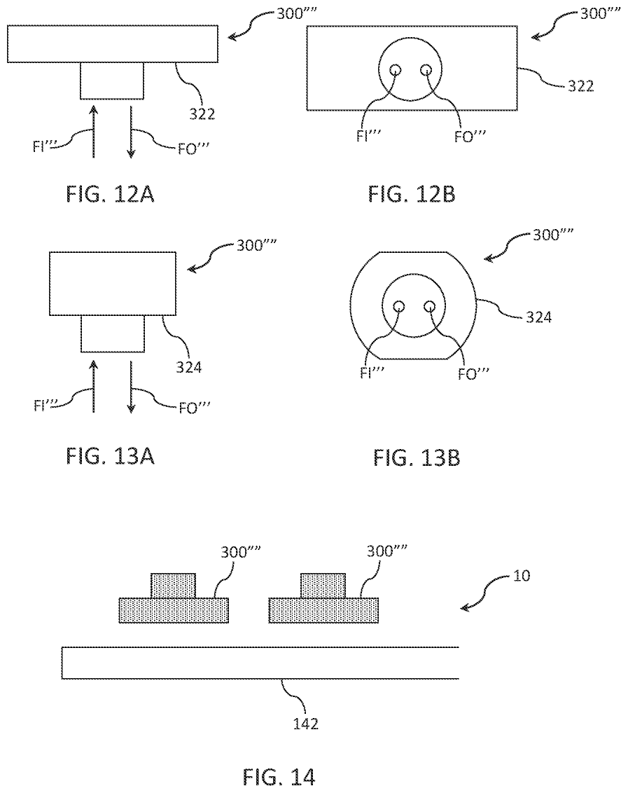

FIGS. 12A and 12B show, respectively, schematic top and side views of an example cooling mechanism 300″″ in accordance with embodiments disclosed herein. Cooling mechanism 300″″ includes thermally conductive member 322 that is configured to allow a working fluid to flow therethrough, wherein, as shown in FIGS. 12A and 12B, working fluid enters conductive member 322 as shown by arrow ‘FI′″’ and exits conductive member 322 as shown by arrow ‘FO′″’.

FIGS. 13A and 13B show, respectively, schematic top and side views of an example cooling mechanism 300″″ in accordance with embodiments disclosed herein. Cooling mechanism 300″″ includes thermally conductive member 324 that is configured to allow a working fluid to flow therethrough, wherein, as shown in FIGS. 13A and 13B, working fluid enters conductive member 324 as shown by arrow ‘FI′″’ and exits conductive member 322 as shown by arrow ‘FO′″’.

While not limited to any specific material, in certain exemplary embodiments, thermally conductive member 322 or 324 may comprise at least one material selected from copper, aluminum, silver, gold, platinum, or nickel and alloys thereof.

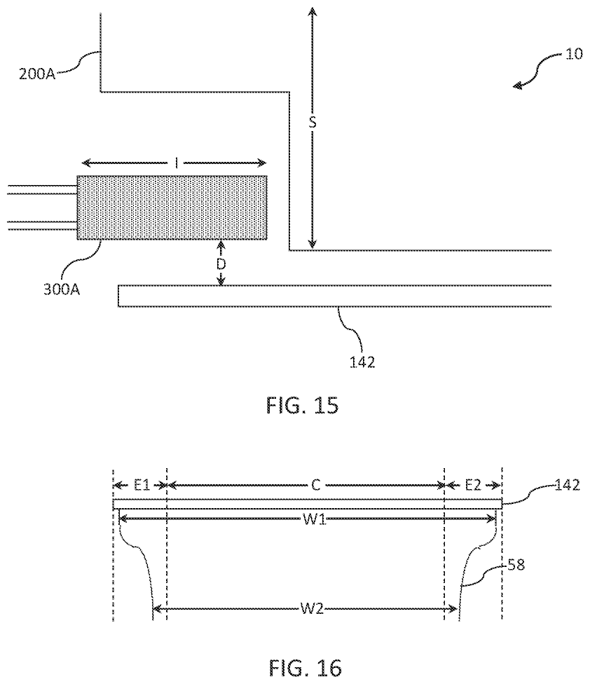

FIG. 14 shows a schematic top view of a portion of an example glass manufacturing apparatus 10 showing positioning of two cooling mechanisms 300″″ relative to delivery slot 142. As shown in FIG. 14 cooling mechanisms 300″″ can be positioned proximate to delivery slot 142, which can be accomplished by methods known to persons having ordinary skill in the art, such as through use of a servo motor and/or counterweight mechanism, etc. In addition, cooling mechanisms 300″″ may be positioned relative to delivery slot 142 independent of each other such that the relative distances between each of cooling mechanisms 300″″ and delivery slot 142 are approximately the same or different. Further, cooling mechanisms 300″″ may be moved relative to delivery slot 142 in the directions indicated by arrows ‘D’ and ‘I’ as described with reference to FIG. 15. Cooling mechanisms 300″″ may also comprise the same or different conductive members, such as, for example, conductive member 322 or conductive member 324.

FIG. 15 shows a schematic top view of a portion of an example glass manufacturing apparatus 10 shown in area ‘X’ of FIG. 4. Relative movements of first heating mechanism 200A and first cooling mechanism 300A are shown by arrows ‘S’, ‘D’, and ‘I’, wherein movement of first heating mechanism 200A between a first position that is relatively farther from the delivery slot 142 and a second position that is relatively closer to the delivery slot 142 is indicated by arrow ‘S’, movement of first cooling mechanism 300A between a first position that is relatively farther from the delivery slot 142 and a second position that is relatively closer to the delivery slot 142 is indicated by arrow ‘D’, and movement of first cooling mechanism 300A between a first position that is relatively farther from first heating mechanism 200A and a second position that is relatively closer to first heating mechanism 200A is indicated by arrow ‘I’. Movement of first heating mechanism 200A and/or first cooling mechanism 300A can be enabled by methods known to persons having ordinary skill in the art, such as through use of a servo motor and/or counterweight mechanism, etc.

With reference to FIG. 11, as well as FIGS. 4 and 5, in certain exemplary embodiments, cooling mechanism 300, including first cooling mechanism 300A, second cooling mechanism 300B, third cooling mechanism 300C, and/or fourth cooling mechanism 300D, can be positioned proximate the delivery slot 142 near the first edge region ‘E1’ and/or the second edge region ‘E2’ prior to the heating mechanism 200 or 200′, including first heating mechanism 200 or 200′ and/or second heating mechanism 200 or 200′, being positioned proximate the delivery slot 142 near the central region ‘C’.

FIG. 16 shows a schematic side view of a glass ribbon 58 flowing from a delivery slot 142. As can be seen from FIG. 16, glass ribbon 58 includes first edge region ‘E1’, central region ‘C’, and second edge region ‘E2’. As can be further seen from FIG. 16, glass ribbon 58 extends in a first widthwise direction ‘W1’ immediately below the delivery slot 142 and a second widthwise dimension ‘W2’ a distance (e.g., one meter) below the delivery slot.

In certain exemplary embodiments, the second widthwise dimension ‘W2’ of glass ribbon 58 is at a distance of about one meter below the delivery slot 142 and is greater than or equal to about 80%, such as greater than or equal to about 85%, and further such as greater than or equal to about 90% of the first widthwise dimension ‘W1’ of glass ribbon 58, including from about 80% to about 95%, such as from about 85% to about 90% of the first widthwise dimension ‘W1’.

In certain exemplary embodiments, an average viscosity of the first edge region ‘E1’ and the second edge region ‘E2’ of the glass ribbon 58 immediately below the delivery slot 142 is greater than or equal to about 5 times, such as greater than or equal to about 10 times, and further such as greater than or equal to about 15 times, such as from about 5 times to about 20 times, and further such as from about 10 times to about 15 times the average viscosity of the central region ‘C’ of the glass ribbon 58 immediately below the delivery slot 142.

In such embodiments, an average viscosity of central region ‘C’ of glass ribbon 58 immediately below the delivery slot 142 may, for example, range from about 10⁴ poise to about 10⁶ poise, such as from about 5×10⁴ poise to about 5×10⁵ poise. In such embodiments, an average viscosity of the first edge region ‘E1’ and the second edge region ‘E2’ of the glass ribbon 58 immediately below the delivery slot 142 may, for example, range from about 5×10⁴ poise to about 10⁸ poise, such as from about 5×10⁵ poise to about 10⁷ poise.

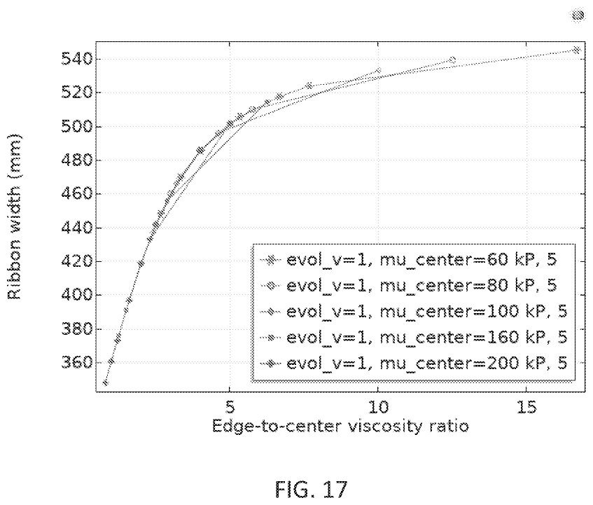

FIG. 17 is a chart showing relationships between modeled edge to center viscosity ratios and glass ribbon width under a variety of conditions, wherein the width of the glass ribbon immediately below the delivery slot is about 600 millimeters and ribbon widths indicated on the Y-axis are at least about one meter below the delivery slot. As can be seen from FIG. 17, as edge to center viscosity ratio increases, glass ribbon width at least one meter below the delivery slot also increases or, in other words, as edge to center viscosity ratio increases, glass ribbon attenuation decreases.

In certain exemplary embodiments, glass ribbon 58 can comprise a glass composition comprising a liquidus viscosity of less than or equal to about 100 kilopoise (kP), such as a liquidus viscosity ranging from about 100 poise (P) to about 100 kilopoise (kP), and further such as a liquidus viscosity ranging from about 500 poise (P) to about 50 kilopoise (kP), and yet further such as a liquidus viscosity ranging from about 1 kilopoise (kP) to about 20 kilopoise (kP) and all ranges and subranges in between.

In certain exemplary embodiments, glass ribbon can comprise a glass composition comprising a liquidus temperature of greater than or equal to about 900° C., such as a liquidus temperature ranging from about 900° C. to about 1,450° C., and further such as a liquidus temperature ranging from about 950° C. to about 1,400° C., and yet further such as a liquidus temperature ranging from about 1,000° C. to about 1,350° C.

While the above embodiments have been described with reference to a slot draw process, it is to be understood that such embodiments are also applicable to other glass forming processes, such as fusion processes, float processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

What is claimed is:

1. A method of manufacturing a glass article comprising:
forming a glass ribbon from a glass delivery device, the glass ribbon extending in a widthwise direction below a delivery orifice of the glass delivery device, the glass ribbon comprising a first edge region, a central region, and a second edge region in the widthwise direction;
positioning a cooling mechanism proximate the delivery orifice near the first edge region and the second edge region; and
positioning a heating mechanism proximate the delivery orifice near the central region.

2. The method of claim 1, wherein the cooling mechanism is positioned proximate the delivery orifice near the first edge region and the second edge region prior to the heating mechanism being positioned proximate the delivery orifice near the central region.

3. The method of claim 2, wherein the step of positioning a cooling mechanism further comprises flowing a working fluid through a thermally conductive member.

4. The method of claim 3, wherein the working fluid comprises a liquid.

5. The method of claim 3, wherein the working fluid comprises a gas.

6. The method of claim 3, wherein the thermally conductive member contacts the delivery orifice near the first edge region and the second edge region.

7. The method of claim 1, wherein the step of positioning a cooling mechanism further comprises flowing a gaseous fluid onto the delivery orifice near the first edge region and the second edge region.

8. The method of claim 1, wherein the step of positioning a cooling mechanism further comprises moving the cooling mechanism between first positions that are relatively farther from the first edge region and the second edge region and second positions that are relatively closer to the first edge region and the second edge region.

9. The method of claim 1, wherein the heating mechanism comprises two coplanar thermally insulative plates that are each movable between a first position that is relatively farther from the delivery orifice and a second position that is relatively closer to the delivery orifice.

10. The method of claim 1, wherein the molten glass comprises a liquidus viscosity of less than or equal to about 100 kilopoise (kP).

11. The method of claim 1, wherein the glass ribbon extends in a first widthwise direction immediately below the delivery orifice and a second widthwise dimension about one meter below the delivery orifice, wherein the second widthwise dimension is greater than or equal to about 80% of the first widthwise dimension.

12. The method of claim 1, wherein an average viscosity of the first edge region and the second edge region of the glass ribbon immediately below the delivery orifice is greater than or equal to about 5 times the average viscosity of the central region of the glass ribbon immediately below the delivery orifice.

13. A glass article manufacturing apparatus comprising:
a glass delivery device comprising a delivery orifice extending in a widthwise direction and comprising a first edge region, a central region, and a second edge region;
a cooling mechanism proximate the delivery orifice near the first edge region and the second edge region; and
a heating mechanism proximate the delivery orifice near the central region.

14. The apparatus of claim 13, wherein the cooling mechanism comprises a thermally conductive member configured to flow a working fluid therethrough.

15. The apparatus of claim 14, wherein the working fluid comprises a liquid.

16. The apparatus of claim 14, wherein the working fluid comprises a gas.

17. The apparatus of claim 14, wherein the thermally conductive member contacts the delivery orifice near the first edge region and the second edge region.

18. The apparatus of claim 13, wherein the cooling mechanism is configured to flow a gaseous fluid onto the delivery orifice near the first edge region and the second edge region.

19. The apparatus of claim 13, wherein the cooling mechanism is movable between first positions that are relatively farther from the first edge region and the second edge region and second positions that are relatively closer to the first edge region and the second edge region.

20. The apparatus of claim 13, wherein the heating mechanism comprises two coplanar thermally insulative plates that are each movable between a first position that is relatively farther from the delivery orifice and a second position that is relatively closer to the delivery orifice.

21. A glass article made by the method of claim 1.

22. An electronic device comprising the glass article of claim 21.
